(19) United States
(12) Patent Application Publication
(10) Pub. No.: US 2009/0325029 A1
(43) Pub. Date: Dec. 31, 2009

(54) MEMBRANE ELECTRODE ASSEMBLY FOR FUEL CELL AND FUEL CELL

(75) Inventors: Yasuhiro Yamashita, Tsukuba (JP); Ryuma Kuroda, Niihama (JP); Mitsuyasu Kawahara, Susono (JP); Masayoshi Takami, Hamamatsu (JP); Tohru Morita, Susono (JP)

Correspondence Address: FOLEY AND LARDNER LLP;SUITE 500, 3000 K STREET NW, WASHINGTON, DC, 20007, US

(73) Assignees: SUMITOMO CHEMICAL COMPANY, LIMITED; TOYOTA JIDOSHA KABUSHIKI KadsAISHA

(21) Appl. No.: 12/310,367

(22) PCT Filed: Aug. 23, 2007
(86) PCT No.: PCT/JP2007/066372

§ 371 Date: Apr. 10, 2009

(30) Foreign Application Priority Data
Aug. 25, 2006 (JP) 2006-228924

(51) Int. Cl. H01M 8/10

(52) U.S. Cl. 429/33; 429/30

(57) ABSTRACT

A membrane electrode assembly for fuel cell that irrespectively of the front or backside of polymeric electrolyte membrane, exhibits high output performance, and that exhibits high junction at an interface between polymeric electrolyte membrane and electrode even under low humidification condition or high temperature condition, or in high current density region, realizing appropriate water management and excellent output characteristics. Further, there is provided a fuel cell including the above assembly. The membrane electrode assembly for fuel cell and fuel cell is one including a polymeric electrolyte membrane containing at least one type of proton conductive polymer; a fuel electrode disposed on one major surface of the polymeric electrolyte membrane; and an oxidizer electrode disposed on the other major surface of the polymeric electrolyte membrane, characterized in that in the use of water contact angle for specifying the hydrophilicity of each surface of the polymeric electrolyte membrane, the difference between the water contact angle on the one major surface of the polymeric electrolyte membrane and that on the other major surface thereof is 30° or less. The provided fuel cell is one having the above assembly.

### TECHNICAL FIELD

The present invention relates to a membrane electrode assembly for fuel cell and a fuel cell comprising the assembly.

### BACKGROUND ART

Fuel cells directly convert chemical energy to electric energy by feeding a fuel and an oxidant to electrically connected two electrodes to cause electrochemical oxidation of the fuel. Being different from thermal electricity generation, fuel cells are not restricted by Carnot's cycle and show high energy conversion efficiency. Fuel cells usually comprise a laminate of a plurality of single cells having, as a basic structure, a membrane electrode assembly comprising an electrolyte membrane interposed between a pair of electrodes. Particularly, solid polymer electrolyte type fuel cells using a solid polymer electrolyte membrane as electrolyte membrane have such merits that they can be readily miniaturized and operated at low temperatures, and thus are noticed as portable and mobile electric sources.

In solid polymer electrolyte type fuel cells, a reaction of the formula (28) proceeds at an anode (fuel electrode).

H₂→2H⁺+2e⁻ (28)

Electrons produced in the reaction of the formula (28) work under external load through external circuit and then reach a cathode (oxidant electrode). Protons produced in the reaction of the formula (28) migrate through solid polymer electrolyte membrane from anode side to cathode side by electroendosmosis in the state of being hydrated with water.

On the other hand, a reaction of the formula (29) proceeds at a cathode.

4H⁺+O₂+4e⁻→2H₂O (29)

As mentioned above, protons produced at anode migrate to cathode through the solid polymer electrolyte membrane, with accompanying some water molecules, and hence it is necessary to keep solid polymer electrolyte membrane and electrodes, particularly, anodes, in high humid state.

In order to keep the humid state of solid polymer electrolyte membrane, for example, a reaction gas (fuel gas, oxidant gas) is fed to electrodes in humidified state. For humidification of reaction gas, an auxiliary equipment is often used. However, if an auxiliary equipment is mounted, there are problems that the fuel cell becomes larger and system becomes complicated, and besides efficiency of electricity generation lowers due to the energy required for operation of the auxiliary equipment. Furthermore, from the theoretical point of fuel cell, it is difficult to keep always the humid state suitable for electricity generation because the amount of water produced at cathode by the electrode reaction and the amount of water accompanying with proton from anode side to cathode side are different depending on operational circumstance of fuel cell. Particularly, in case operation is carried out at high current density, retention of water on anode side, namely, so-called flooding, is apt to occur. As a result of feeding of oxidant being hindered due to the flooding, over-voltage increases to cause decrease of output voltage.

Therefore, it has been desired that the humid state of the solid polymer electrolyte membrane can be kept without humidification of reaction gas or even with the minimum humidification. However, the electrolyte membrane is apt to be in dry state during operation at high current density under low humidification conditions, resulting in reduction of proton conductivity.

Moreover, in order to enhance catalytic activity of catalyst component which accelerates electrode reaction, it is preferred to operate fuel cell under high temperature conditions. However, high temperature operation often causes evaporation of water in the electrolyte membrane to result in dry state and reduce proton conductivity.

Especially, on the anode side, no water is produced from the electrode reaction, and furthermore water migrates to cathode side together with proton, and hence the electrolyte membrane is apt to dry.

Various technologies have been proposed for the purpose of keeping the humid state of solid polymer electrolyte membrane or inhibiting retention of water in electrodes (Patent Documents 1-5). For example, Patent Document 1 discloses a method for making a membrane electrode assembly for solid polymer type fuel cell which comprises forming a proton conductive polymer layer having EW (equivalent weight of exchange group having proton conductivity) larger than EW of solid polymer electrolyte membrane on the cathode catalyst layer, and a proton conductive polymer layer having EW smaller than EW of solid polymer electrolyte membrane on the anode catalyst layer, and then bonding the electrode having catalyst layer and a solid polymer electrolyte membrane under heating and pressing.

Patent Document 2 discloses a solid polymer type fuel cell comprising a polymer electrolyte membrane and an anode side catalyst layer or a cathode side catalyst layer, between which a hydrophilic layer is formed. It further proposes an embodiment that the surface of the polymer electrolyte membrane on which the anode side catalyst layer or cathode side catalyst layer is laminated is made hydrophilic by irradiation with electron rays to form the hydrophilic layer.

Patent Document 1: JP-A-11-40172

Patent Document 2: JP-A-2005-25974

Patent Document 3: JP-A-10-284087

Patent Document 4: JP-A-2003-272637

Patent Document 5: JP-A-2005-317287

### DISCLOSURE OF INVENTION

### Problem to be Solved by the Invention

According to the technology disclosed in Patent Document 1, in some case, retention of water in catalyst layer can be inhibited and besides the polymer electrolyte membrane can be inhibited from drying by preventing migration of water accompanied by proton to cathode by a proton conductive polymer layer formed between the polymer electrolyte and the catalyst layer. However, if enough bonding is not attained between the proton conductive polymer layer and the electrolyte membrane, there are problems that over-voltage occurs to reduce output voltage. Furthermore, distribution of water in the polymer electrolyte membrane is not uniform between anode side and cathode side, and as a result, drying of the anode side cannot be sufficiently inhibited, and electricity generation performance cannot be improved. Moreover, the number of steps for forming proton conductive layer increases to cause reduction in productivity.

On the other hand, the technology disclosed in Patent Document 2 of returning water produced in cathode side catalyst layer to polymer electrolyte membrane and utilizing the water for humidification of the polymer electrolyte membrane by providing a hydrophilic layer higher in hydrophilicity than the catalyst layer between the polymer electrolyte membrane and the catalyst layer. For increasing this effect, it is preferred to provide a hydrophilic layer between polymer electrolyte membrane and cathode side catalyst layer. When a hydrophilic layer is provided on the cathode side, distribution of water in the polymer electrolyte membrane is not uniform between anode side and cathode side, and as a result, drying of the anode side cannot be sufficiently inhibited, and electricity generation performance may not be improved. Both cases of providing a hydrophilic layer separately and giving hydrophilicity to the polymer electrolyte membrane by irradiation with electron rays cause increase of the number of steps, resulting in reduction of productivity.

The present invention has been accomplished in view of the above circumstances, and the object is to provide a membrane electrode assembly for fuel cell that irrespectively of the front or backside of polymer electrolyte membrane, exhibits high output performance, and that exhibits strong bonding at an interface between polymer electrolyte membrane-electrode even under low humidification conditions or high temperature conditions, or in high current density region, realizing appropriate water management and excellent output performance, and a fuel cell having the assembly.

### Means for Solving the Problem

The membrane electrode assembly for fuel cell (hereinafter sometimes referred to as merely “membrane electrode assembly”) of the present invention comprises a polymer electrolyte membrane comprising at least one proton conductive polymer, a fuel electrode disposed on one surface of the polymer electrolyte membrane, and an oxidant electrode disposed on another surface of the polymer electrolyte membrane, wherein when hydrophilicity of the surface of the polymer electrolyte membrane is specified by water contact angle, the difference between the water contact angle on one surface of the polymer electrolyte membrane and that on another surface thereof is 30° or less.

According to the present invention, a membrane electrode assembly for fuel cell that irrespectively of the front or backside of polymer electrolyte membrane exhibits high electricity generation performance can be obtained by using a polymer electrolyte membrane in which difference in hydrophlicity of both surfaces thereof is small, and difference in water contact angle on both surfaces, namely, difference between the water contact angle on one surface and that on another surface is 30° or less. In production of the membrane electrode assembly, there is no need to make distinction between front and backside of the polymer electrolyte membrane, and thus handleability is improved. Furthermore, by using a polymer electrolyte membrane both surfaces of which are high in hydrophilicity, a membrane electrode assembly which is high in bonding at an interface of membrane-electrode, easy in migration of water and excellent in water management is obtained irrespectively of combination of front and backside of the polymer electrolyte membrane with fuel electrode side and oxidant electrode side.

As a result, proton conduction becomes smooth at the interface of membrane-electrode and electricity generation can be improved even under the conditions where the polymer electrolyte membrane and fuel electrode are apt to dry, such as operations under low humidification condition and high temperature condition, and in high current density region.

The difference in water contact angle is 30° or less, preferably 20° or less, more preferably 10° or less, and it is further preferred that the water contact angles on both surfaces are equal.

Furthermore, in order that the bonding at the interface of membrane-electrode is strong and water can easily migrate, the water contact angles on both surfaces of the polymer electrolyte membrane are preferably 10° or more and 60° or less, more preferably 20° or more and 50° or less.

The materials constituting the polymer electrolyte membrane include, for example, hydrocarbon polymer electrolyte membranes comprising proton conductive polymers.

The proton conductive polymers are preferably polymers having an aromatic ring in main chain and a proton exchange group directly bonded to the aromatic ring or indirectly bonded to the aromatic ring through other atom or atomic group.

The proton conductive polymers may have a side chain.

The proton conductive polymers may have an aromatic ring in main chain and furthermore a side chain comprising an aromatic ring, and preferably at least one of the aromatic ring of the main chain and the aromatic ring of the side chain comprises a proton exchange group directly bonded to the aromatic ring.

The proton exchange group is preferably a sulfonic acid group.

As further specific examples of the proton conductive polymers, mention may be made of the following ones.

Those which have at least one repeat unit having proton exchange group and selected from those having the following formulas (1a)-(4a):

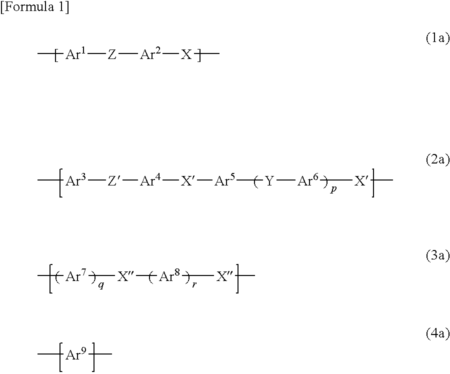

(in the above formulas, Ar¹-Ar⁹ independently of one another represent a divalent aromatic group which comprises an aromatic ring in main chain and may have further a side chain comprising an aromatic ring, with the proviso that at least one of the aromatic ring of the main chain and the aromatic ring of the side chain comprises a proton exchange group directly bonded to the aromatic ring, Z and Z′ independently of one another represent CO or SO₂, X, X′ and X″ independently of one another represent O or S, Y represents a direct bonding or a methylene group which may have a substituent, p represents 0, 1 or 2, and q and r independently of one another represent 1, 2 or 3) and
at least one repeat unit having substantially no proton exchange group and selected from those having the following formulas (1b)-(4b):

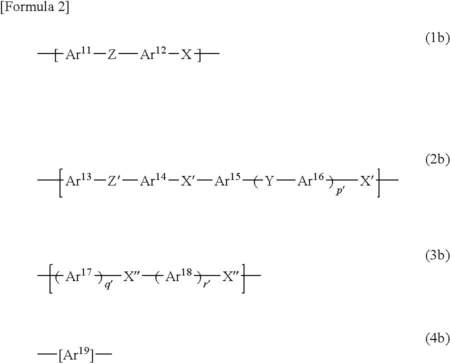

(in the above formulas, Ar¹¹-Ar¹⁹ independently of one another represent a divalent aromatic group which may have a substituent as a side chain, Z and Z′ independently of one another represent CO or SO₂, X, X′ and X″ independently of one another represent O or S, Y represents a direct bonding or a methylene group which may have a substituent, p′ represents 0, 1 or 2, and q′ and r′ independently of one another represent 1, 2 or 3).

The proton conductive polymers are preferably block copolymers comprising a block (A) having proton exchange group and a block (B) having substantially no proton exchange group because a micro phase separation structure mentioned hereinafter is readily formed in the polymer electrolyte membrane.

When the polymer electrolyte membrane comprises a structure of micro phase being separated into two or more phases, the hydrophilicity of both surfaces of the polymer electrolyte membrane can be easily controlled.

As preferred polymer electrolyte membranes having a micro phase separation structure, mention may be made of those which contain as the proton conductive polymer a block copolymer comprising a block (A) having proton exchange group and a block (B) having substantially no proton exchange group and have a micro phase separation structure comprising a phase where density of the block (A) having proton exchange group is high and a phase where density of the block (B) having substantially no proton exchange group is high.

Specific examples are those which have as the proton conductive polymer a block copolymer having at least one block (A) having proton exchange group and at least one block (B) having substantially no proton exchange group, where the block (A) having proton exchange group comprises the repeat structure represented by the following formula (4a′) and the block (B) having substantially no proton exchange group contains at least one of the repeat structures represented by the following formulas (1b′), (2b′) and (3b′).

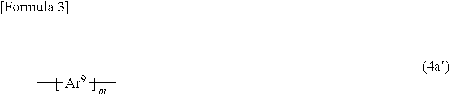

(in the above formula, m represents an integer of 5 or more, and Ar⁹ represents a divalent aromatic group which may be substituted with a fluorine atom, a substituted or unsubstituted alkyl group of 1-10 carbon atoms, an alkoxy group of 1-10 carbon atoms, an aryl group of 6-18 carbon atoms, an aryloxy group of 6-18 carbon atoms or an acyl group of 2-20 carbon atoms, and Ar⁹ comprises a proton exchange group bonded directly or through a side chain to an aromatic ring constituting the main chain),

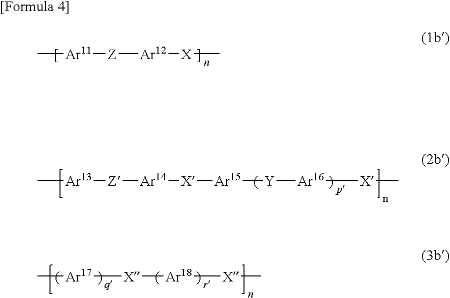

(in the above formulas, n represents an integer of 5 or more, and Ar¹¹-Ar¹⁸ independently of one another represent a divalent aromatic group which may be substituted with an alkyl group of 1-18 carbon atoms, an alkoxy group of 1-10 carbon atoms, an aryl group of 6-10 carbon atoms, an aryloxy group of 6-18 carbon atoms or an acyl group of 2-20 carbon atoms, and other signs are the same as defined in the formulas (1b)-(3b)).

Moreover, the proton conductive polymers include those which have one or more blocks (A) having proton exchange group and one or more blocks (B) having substantially no proton exchange group, the proton exchange group being directly bonded to the aromatic ring of the main chain in the block having proton exchange group.

Further, the proton conductive polymers include those which have one or more blocks (A) having proton exchange group and one or more blocks (B) having substantially no proton exchange group, and the block (A) having proton exchange group and the block (B) having substantially no proton exchange group both do not have a substituent group comprising a halogen atom.

It is preferred that both the surfaces of the polymer electrolyte membrane are not subjected to surface treatment because there may occur deterioration in productivity or chemical or physical deterioration of the polymer electrolyte membrane.

The polymer electrolyte membrane is suitably one which is prepared by cast coating a solution comprising the proton conductive polymer constituting the polymer electrolyte membrane on a specific supporting base and drying the coat to form a film.

As the supporting base, there may be used a continuous supporting base in which the surface to be cast coated is made of a metal or a metal oxide.

According to the membrane electrode assembly for fuel cell of the present invention a fuel cell can be provided which exhibits excellent electricity generation performance under the conditions where the polymer electrolyte membrane is apt to be dried, and which can be operated under wide humidification conditions of from low humidification conditions to high humidification conditions, in a high current density region and besides under high temperature conditions.

### Advantages of the Invention

According to the membrane electrode assembly of the present invention as mentioned above, a membrane-electrode assembly and a fuel cell can be provided which irrespectively of the front or backside of polymer electrolyte membrane, exhibits high output performance, and that exhibits high bonding at an interface of polymer electrolyte membrane-electrode even under low humidification condition or high temperature condition, or in high current density region, realizing appropriate water management and excellent output performance.

### BEST MODE FOR CARRYING OUT THE INVENTION

The membrane electrode assembly for fuel cell of the present invention comprises a polymer electrolyte membrane comprising at least one proton conductive polymer, a fuel electrode disposed on one surface of the polymer electrolyte membrane, and an oxidant electrode disposed on another surface of the polymer electrolyte membrane, wherein when hydrophilicity of the surface of the polymer electrolyte membrane is specified in terms of water contact angle, the difference between the water contact angle on one surface of the polymer electrolyte membrane and that on another surface thereof is 30° or less.

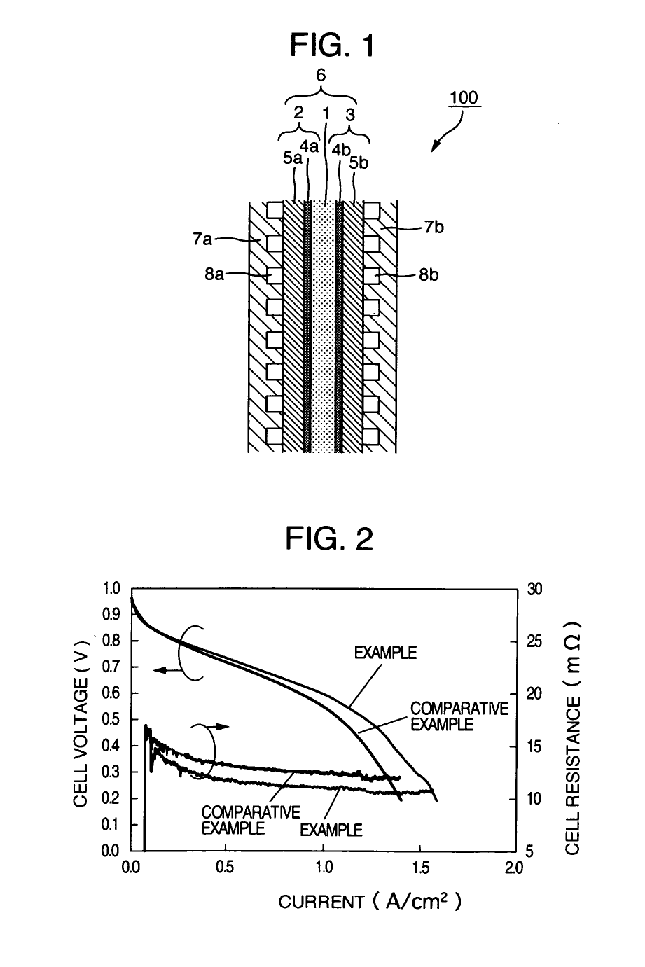

FIG. 1 is a schematic view showing one embodiment of the membrane electrode assembly for fuel cell of the present invention. In FIG. 1, single cell of fuel cell (hereinafter sometimes referred to as merely “single cell”) 100 includes a membrane electrode assembly 6 having a fuel electrode (anode) 2 disposed on one surface of a polymer electrolyte membrane 1 and an oxidant electrode (cathode) 3 disposed on another surface of the polymer electrolyte membrane 1. In this embodiment, the fuel electrode 2 and oxidant electrode 3 have respectively such a structure that a fuel electrode side catalyst layer 4a and a fuel electrode side gas diffusion layer 5a are laminated successively on one side of the electrolyte membrane, and an oxidant electrode side catalyst layer 4b and an oxidant electrode side gas diffusion layer 5b are laminated successively on another side of the electrolyte membrane. The catalyst layers 4a and 4b of each electrode (fuel electrode, oxidant electrode) contain an electrode catalyst (not shown) having catalytic activity for electrode reaction, and electrode reactions take place at the electrode catalyst. The gas diffusion layers 5a and 5b are for enhancing the electron collection performance of electrodes or diffusibility of reaction gas into the catalyst layers 4.

In the present invention, the structure of each electrode is not limited to one shown in FIG. 1, and may comprise only the catalyst layer or may have a layer other than the catalyst layer and the gas diffusion layer.

The membrane electrode assembly 6 is interposed between a fuel electrode side separator 7a and an oxidant electrode side separator 7b to construct a single cell 100 of fuel cell. The separators 7 have flow channels 8 (8a, 8b), and perform gas sealing between the single cells and besides function as electron collectors. A fuel gas (gas comprising hydrogen or gas generating hydrogen, usually hydrogen gas) is fed to fuel electrode 2 from flow channel 8a, and oxidant gas (gas containing oxygen or gas generating oxygen, usually air) is fed to oxidant electrode 3 from flow channel 8b. The fuel cell generates electricity by the reaction of the fuel and the oxidant.

The single cells 100 are usually stacked and the stack is incorporated in a fuel cell.

As mentioned above, the membrane electrode assembly is liable to dry on fuel electrode (anode) side as compared with oxidant electrode (cathode) side. This is because protons produced at the fuel electrode migrate to oxidant electrode side being accompanied with water, and water is produced at the oxidant electrode by electrode reaction.

The inventors have found that a fuel cell which irrespectively of the front or backside of polymer electrolyte membrane exhibits high electricity generation performance can be obtained by using a polymer electrolyte membrane small in difference of hydrophilicity on both surfaces, and there is no need to make distinction between front and backside of the polymer electrolyte membrane at production steps, and thus handleability is improved. Furthermore, it has been found that a membrane electrode assembly which is high in bonding at an interface of membrane-electrode, easy in migration of water and excellent in water management can be obtained, irrespective of combination of front and backside of the polymer electrolyte membrane with fuel electrode side and oxidant electrode side, by using a polymer electrolyte membrane high in hydrophilicity on both surfaces.

The expressions “hydrophilicity is relatively low” and “hydrophilicity is relatively high” used in the present invention refer to low and high hydrophilicities which are relatively compared on one surface and another surface of the electrolyte membrane. Hereinafter, mere expressions “hydrophilicity is high” and “hydrophilicity is low” mean high and low hydrophilicities in relative meaning.

Furthermore, the expressions “water contact angle is relatively small” and “water contact angle is relatively large” used in the present invention refer to small and large water contact angles which are relatively compared on one surface and another surface of the electrolyte membrane. Hereinafter, mere expressions “water contact angle is small” and “water contact angle is large” mean small and large water contact angles in relative meaning.

The polymer electrolyte membrane used in the membrane electrode assembly of the present invention will be explained in detail below.

In the membrane electrode assembly of the present invention, there is used a polymer electrolyte membrane in which the difference in hydrophilicity of both surfaces is small and the difference in water contact angle on one surface of the polymer electrolyte membrane and that on another surface thereof is 30° or less.

Here, the water contact angle on the surface of the polymer electrolyte membrane is a value obtained by leaving the polymer electrolyte membrane in an atmosphere of 23° C. 50% RH for 24 hours, and thereafter conducting measurement using a contact angle meter (e.g., model CA-A manufactured by Kyowa Interface Science Co., Ltd.) by dropping a water drop of 2.0 mm in diameter on the surface of the polymer electrolyte membrane and, after 5 seconds, measuring a contact angle between the surface of the membrane and the water drop by droplet method.

The water contact angle on the surface of the polymer electrolyte membrane is an indication of hydrophilicity of the surface of the polymer electrolyte membrane, and the smaller the contact angle, the higher the hydrophilicity, and the larger the contact angle, the lower the hydrophilicity.

The method for measurement of water contact angle is relatively simple, and the water contact angle is suitable as a means for evaluation of hydrophilicity of the surface of the polymer electrolyte membrane.

The difference between the water contact angle on one surface of the polymer electrolyte membrane (hereinafter sometimes referred to as “θ₁”) and that on another surface thereof (hereinafter sometimes referred to as “θ₂”) is 30° or less. Here, when θ₁ and θ₂ are different, the surface on which the angle is smaller (the hydrophilicity is higher) is hereinafter sometimes referred to as “the first surface”, and the surface on which the angle is larger (the hydrophilicity is lower) is hereinafter sometimes referred to as “the second surface”.

From the viewpoint of adhesion to the fuel cell electrodes, it is preferred that θ₁ and θ₂ of the polymer electrolyte membrane are both 10° or more and 60° or less, preferably 10° or more and 50° or less.

When θ₁ and θ₂ are both 10° or more, the surface of the polymer electrolyte membrane is appropriately hydrophilic, and the membrane is superior in form stability during absorption of water, and when θ₁ and θ₂ are both 60° or less, the adhesion between the polymer electrolyte membrane and the fuel cell electrode is stronger, which is preferred.

As the proton conductive polymers constituting the polymer electrolyte membrane, there may be used those which have proton exchange group, develop proton conductivity and are generally used for solid polymer type fuel cells, and they may be used alone or in combination of two or more.

It is preferred that the polymer electrolyte membrane comprises the proton conductive polymer in an amount of 50 wt % or more, preferably 70 wt % or more, especially preferably 90 wt % or more.

The amount of proton exchange group introduced which serves for proton conduction in the polymer electrolyte membrane is preferably 0.5 meq/g-4.0 meq/g, more preferably 1.0 meq/g-2.8 meq/g in terms of ion exchange capacity. When the ion exchange capacity which shows the amount of proton exchange group introduced is 0.5 meq/g or more, the proton conductivity becomes higher, and the function as polymer electrolyte membrane for fuel cell is superior, which is preferred. On the other hand, when the ion exchange capacity which shows the amount of proton exchange group introduced is 4.0 meq/g or less, water resistance becomes higher, which is preferred.

Examples of the proton conductive polymers are hydrocarbon proton conductive polymers.

The hydrocarbon proton conductive polymers preferably do not contain fluorine. As hydrocarbon proton conductive polymers, mention may be made of, for example, engineering plastics having aromatic main chain such as polyether ether ketone, polyether ketone, polyether sulfone, polyphenylene sulfide, polyphenylene ether, polyether ether sulfone, polyparaphenylene and polyimide, and general purpose plastics such as polyethylene and polystyrene into which is introduced a proton conductive group such as sulfonic acid group, carboxylic acid group, phosphoric acid group, phosphonic acid group or sulfonylimide group.

Hydrocarbon polymer electrolytes have the merit that they are inexpensive as compared with fluorine-containing polymer electrolytes. Among them, from the viewpoint of heat resistance, preferred are hydrocarbon polymer electrolytes using hydrocarbon proton conductive polymers obtained by introducing proton exchange group into aromatic hydrocarbon polymers having aromatic ring in the main chain.

The hydrocarbon proton conductive polymers preferably have an aromatic ring in the main chain and a proton exchange group bonded directly or indirectly through other atom or atomic group to the aromatic ring.

The hydrocarbon proton conductive polymers may have a side chain.

The preferred polymers are the hydrocarbon proton conductive polymers which comprise an aromatic ring in the main chain and may comprise further a side chain comprising an aromatic ring, and at least one of the aromatic ring of the main chain and the aromatic ring of the side chain comprises a proton exchange group directly bonded to the aromatic ring.

In the present invention, as the polymer electrolyte membrane, a hydrocarbon polymer electrolyte membrane comprising a hydrocarbon polymer electrolyte is preferred, and a hydrocarbon polymer electrolyte membrane comprising a hydrocarbon polymer electrolyte in an amount of 50 wt % or more is particularly preferred, and a hydrocarbon polymer electrolyte membrane comprising a hydrocarbon polymer electrolyte in an amount of 80 wt % or more is further preferred. However, the polymer electrolyte membrane may contain other polymers, proton conductive polymers which are not hydrocarbon, and additives so far as not affecting the effects of the present invention.

According to the present invention, the difference in hydrophilicity on both surfaces of the polymer electrolyte membrane per se is as low as possible, and the present invention does not include the polymer electrode membrane in which proton conductive polymers having small difference in hydrophilicity or proton conductive polymers having the same hydrophilicity are coated or laminated on both surfaces or one of the surfaces of the polymer electrolyted membrane. That is, the polymer electrolyte membrane used in the membrane electrode assembly of the present invention is typically formed using one composition comprising at least one proton conductive polymer.

Polymer electrolyte membrane the hydrophilicities of both surfaces of which are made small or equal by coating or laminating a material having the desired hydrophilicity, for example, coating or laminating a plurality of proton conductive polymers, sometimes becomes insufficient in adhesion at interface of coated or laminated portion, and separation at the interface is apt to occur, which may cause deterioration of proton conductivity or reduction of voltage.

The surface of the membrane may be subjected to surface treatment or the like, but from the viewpoints of shortening of production steps and inhibition of chemical or physical deterioration of the polymer electrolyte membrane, preferred is polymer electrolyte membrane which is reduced in difference between the water contact angles on both surfaces without carrying out post-treatments such as surface treatment.

According to the present invention, in producing a polymer electrolyte membrane by so-called solution casting method, the difference between the contact angles on both surfaces of the polymer electrolyte membrane can be made small by casting a solution comprising proton conductive polymer (polymer electrolyte solution), preferably a solution showing a micro phase separation structure mentioned hereinafter at membrane formation on the surface of a suitable supporting base, preferably a supporting base having a metal layer or metal oxide layer on the surface even when post processing such as surface treatment is not carried out after formation of membrane. That is, hydrophilicity of both surfaces of the membrane can be controlled without carrying out post treatment of the membrane formed by solution casting method. However, the surface of the membrane may be subjected to surface treatment for further optimizing the difference in contact angle obtained at the step of membrane formation.

The control of the water contact angle by the surface of the polymer electrolyte membrane by solution casting method is considered as follows. It is presumed that depending on the combination of material constituting the polymer electrolyte membrane comprising proton conductive polymer with the supporting base, the difference between the water contact angle on one surface which is bonded to the supporting base and that on another surface which contacts with air in casting decreases due to the combination of interaction between the polymer electrolyte in the state of solution in solution casting and the supporting base with interaction between air and the polymer electrolyte in the state of solution.

That is, by cast coating on the surface of a suitable supporting base a polymer electrolyte solution, preferably a solution which shows micro phase separation structure upon formation of membrane, the contact angle on the resulting coat on the side of the supporting base can be nearly the same as the contact angle on another surface (air side) due to the interaction between the polymer electrolyte and the base.

In control of water contact angle by solution casting method as mentioned above, the production steps can be shortened by the omission of surface treatment as compared with the case of carrying out the post-treatments such as surface treatment, which is industrially very advantageous. Furthermore, the surface treatment may cause chemical or physical deterioration of the polymer electrolyte membrane, and this can be avoided according to the above method.

As the proton conductive polymers constituting the polymer electrolyte membrane which is produced by solution casting method (without carrying out post-treatments) and has small difference in water contact angle on both surfaces, there may be used those which are mentioned hereinbefore.

In more detail, the proton conductive polymers are preferably those which include copolymers such as random copolymer, block copolymer, graft copolymer and alternating copolymer, and more preferred are block copolymers and graft copolymers having at least one polymer segment having proton exchange group and at least one polymer segment having substantially no proton exchange group. Further preferred are block copolymers having at least one polymer block (A) having proton exchange group and at least one polymer block (B) having substantially no proton exchange group.

Further preferred are block copolymers having at least one polymer block (A) having proton exchange group and at least one polymer block (B) having substantially no proton exchange group in which the proton exchange group in the block having proton exchange group is directly bonded to the aromatic ring in the main chain.

In the present invention, that polymer, polymer segment, block or repeat unit “substantially has proton exchange group” means that the proton exchange group is contained in the number of 0.5 or more on the average per one repeat unit, more preferably 1.0 or more on the average per one repeat unit. On the other hand, that they “have substantially no proton exchange group” means a segment comprising proton exchange group in the number of less than 0.5 on the average per one repeat unit, preferably less than 0.1 on the average per one repeat unit, further preferably less than 0.05 on the average.

When the proton conductive polymer comprises block copolymer, the block copolymer preferably comprises block (A) having proton exchange group and block (B) having substantially no proton exchange group.

It is preferred that the proton conductive polymer comprises block copolymer because micro phase separation structure is readily formed. The micro phase separation structure here means a structure formed by occurrence of microscopic phase separation on the order of molecular chain size by chemical bonding of different polymer segments per se in block copolymers or graft copolymers. For example, it means a structure in which micro phase (micro domain) high in density of block (A) having proton exchange group and micro phase (micro domain) high in density of block (B) having substantially no proton exchange group are present together, and domain width, namely, identity period of each micro domain structure is several nm-several hundred nm when observed under a transmission electron microscope (TEM). The proton conductive polymers preferably have micro domain structure of 5 nm-100 nm.

As a reason for those having micro phase separation structure being preferred, it can be hypothesized that since the micro phase separation structure has microscopic agglomerates, a strong interaction such as affinity or repulsion works between the proton conductive polymer and the supporting base in cast coating of a polymer electrolyte solution in solution casting method, whereby the contact angle is controlled.

As the proton conductive polymers used for the polymer electrolyte membrane of the present invention, mention may be made of, for example, polymers having structures disclosed in JP-A-2005-126684 (US2007/83010A) and JP-A-2005-206807 (US2007/148518A).

More specifically, mention may be made of proton conductive polymers which contain at least one of the repeat units of the above formulas (1a), (2a), (3a) and (4a) and at least one of the repeat units of the formulas (1b), (2b), (3b) and (4b) and which have a polymer type such as block copolymer, alternating copolymer and random copolymer.

Furthermore, preferred are block copolymers having at least one block comprising a repeat unit having a proton exchange group and selected from those of the formulas (1a), (2a), (3a) and (4a) and at least one block comprising a repeat unit comprising substantially no proton exchange group and selected from those of the formulas (1b), (2b), (3b) and (4b). More preferred are copolymers having the following blocks.

<i> A block comprising a repeat unit of (1a) and a block comprising a repeat unit of (1b),

<ii> a block comprising a repeat unit of (1a) and a block comprising a repeat unit of (2b),

<iii> a block comprising a repeat unit of (2a) and a block comprising a repeat unit of (1b),

<iv> a block comprising a repeat unit of (2a) and a block comprising a repeat unit of (2b),

<v> a block comprising a repeat unit of (3a) and a block comprising a repeat unit of (1b),

<vi> a block comprising a repeat unit of (3a) and a block comprising a repeat unit of (2b),

<vii> a block comprising a repeat unit of (4a) and a block comprising a repeat unit of (1b),

<viii> a block comprising a repeat unit of (4a) and a block comprising a repeat unit of (2b), etc.

More preferred are those which have the above <ii>, <iii>, <iv>, <vii>, and <viii>, and especially preferred are those which have the above <vii> and <viii>.

In the present invention, more preferred are block copolymers in which the repeating number of (4a), namely, m in the formula (4a′) is an integer of 5 or more. The value of m is more preferably 5-1000, further preferably 10-500. When m is 5 or more, proton conductivity is sufficient as polymer electrolyte for fuel cell. When m is 1000 or less, it can be more easily produced.

Ar⁹ in the formula (4a′) represents a divalent aromatic group. Examples of the divalent aromatic group are divalent monocyclic aromatic group such as 1,3-phenylene and 1,4-phenylene, divalent fused ring aromatic groups such as 1,3-naphthalenediyl, 1,4-naphthalenediyl, 1,5-naphthalenediyl, 1,6-naphthalenediyl, 1,7-naphthalenediyl, 2,6-naphthalenediyl and 2,7-naphthalenediyl, divalent hetero aromatic groups such as pyridinediyl, quinoxalinediyl and thiophenediyl, and the like. Preferred are divalent monocyclic aromatic groups.

Ar⁹ may be substituted with a fluorine atom, an alkyl group of 1-10 carbon atoms which may have a substituent, an alkoxy group of 1-10 carbon atoms which may have a substituent, an aryl group of 6-18 carbon atoms which may have a substituent, an aryloxy group of 6-18 carbon atoms which may have a substituent or an acyl group of 2-20 carbon atoms which may have a substituent.

Ar⁹ has at least one proton exchange group bonded to an aromatic ring constituting the main chain. The proton exchange group is more preferably an acidic group (a cation exchange group), which is preferably sulfonic acid group, phosphonic acid group or carboxylic acid group. Among them, sulfonic acid group is further preferred.

These proton exchange groups may be partially or wholly replaced with metal ion to form a salt, but in the case of using as a polymer electrolyte membrane for fuel cell, it is preferred that substantially all of them are in the state of free acid.

As an preferred example of the repeat unit shown by the formula (4a′), mention may be made of the structure of the following formula.

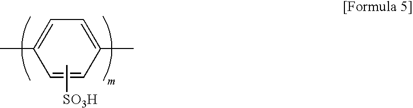

In the present invention, more preferred block copolymers are those of the repeating number of (1b)-(3b), namely, n in the formulas (1b′)-(3b′) being an integer of 5 or more. The value of n is preferably 5-1000, more preferably 10-500. When n is 5 or more, proton conductivity is sufficient as polymer electrolyte for fuel cell. When n is 1000 or less, they can be more easily produced.

Ar¹¹-Ar¹⁸ in the formulas (1b′)-(3b′) independently of one another represent a divalent aromatic group. Examples of the divalent aromatic group are divalent monocyclic aromatic groups such as 1,3-phenylene and 1,4-phenylene, divalent fused ring aromatic groups such as 1,3-naphthalenediyl, 1,4-naphthalenediyl, 1,5-naphthalenediyl, 1,6-naphthalenediyl, 1,7-naphthalenediyl, 2,6-naphthalenediyl and 2,7-naphthalenediyl, divalent hetero aromatic groups such as pyridinediyl, quinoxalinediyl and thiophenediyl, and the like. Preferred are divalent monocyclic aromatic groups.

Furthermore, Ar¹¹-Ar¹⁸ may be substituted with an alkyl group of 1-18 carbon atoms, an alkoxy group of 1-10 carbon atoms, an aryl group of 6-10 carbon atoms, an aryloxy group of 6-18 carbon atoms or an acyl group of 2-20 carbon atoms.

Specific examples of the proton conductive polymers are those having the following structures (1)-(26).

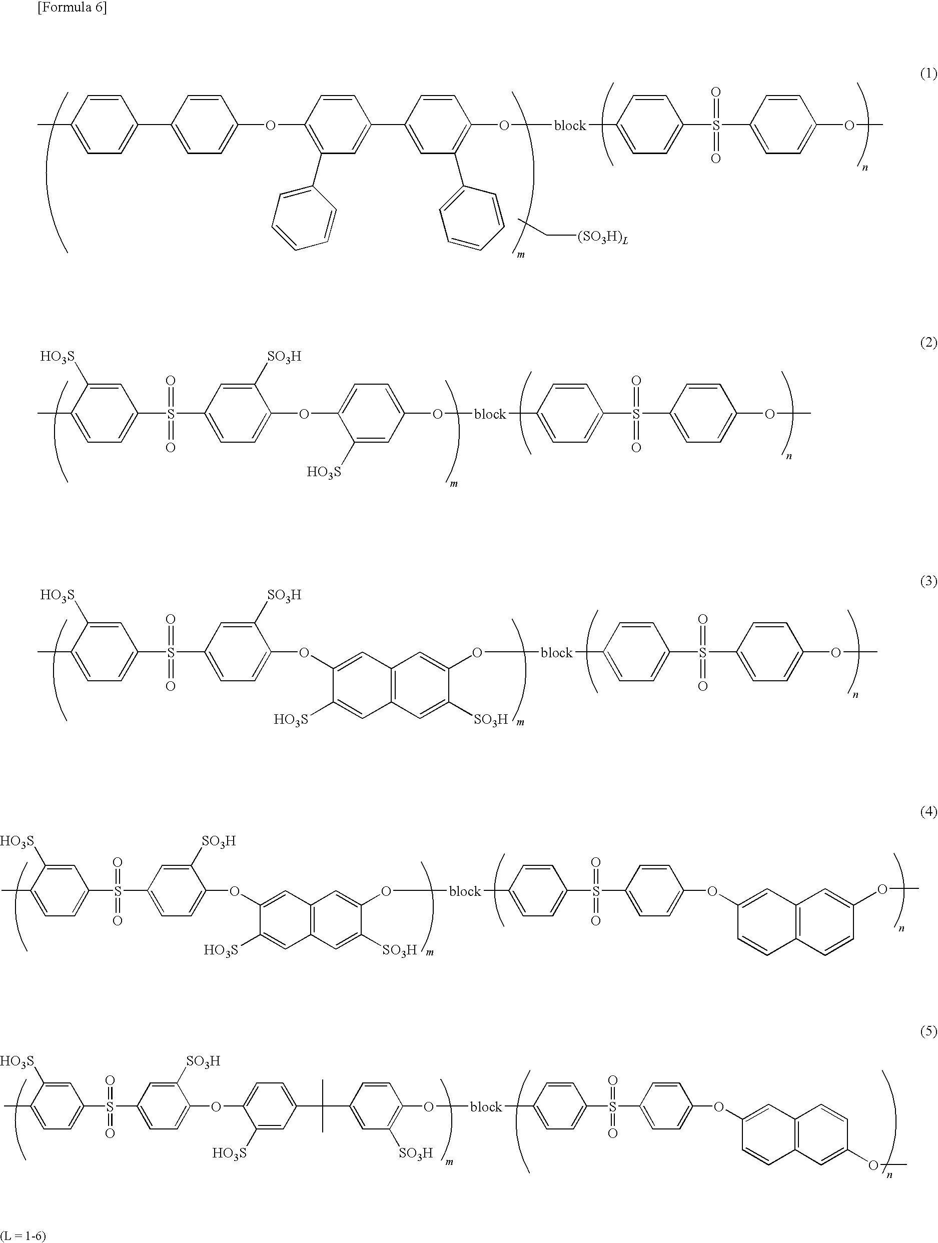

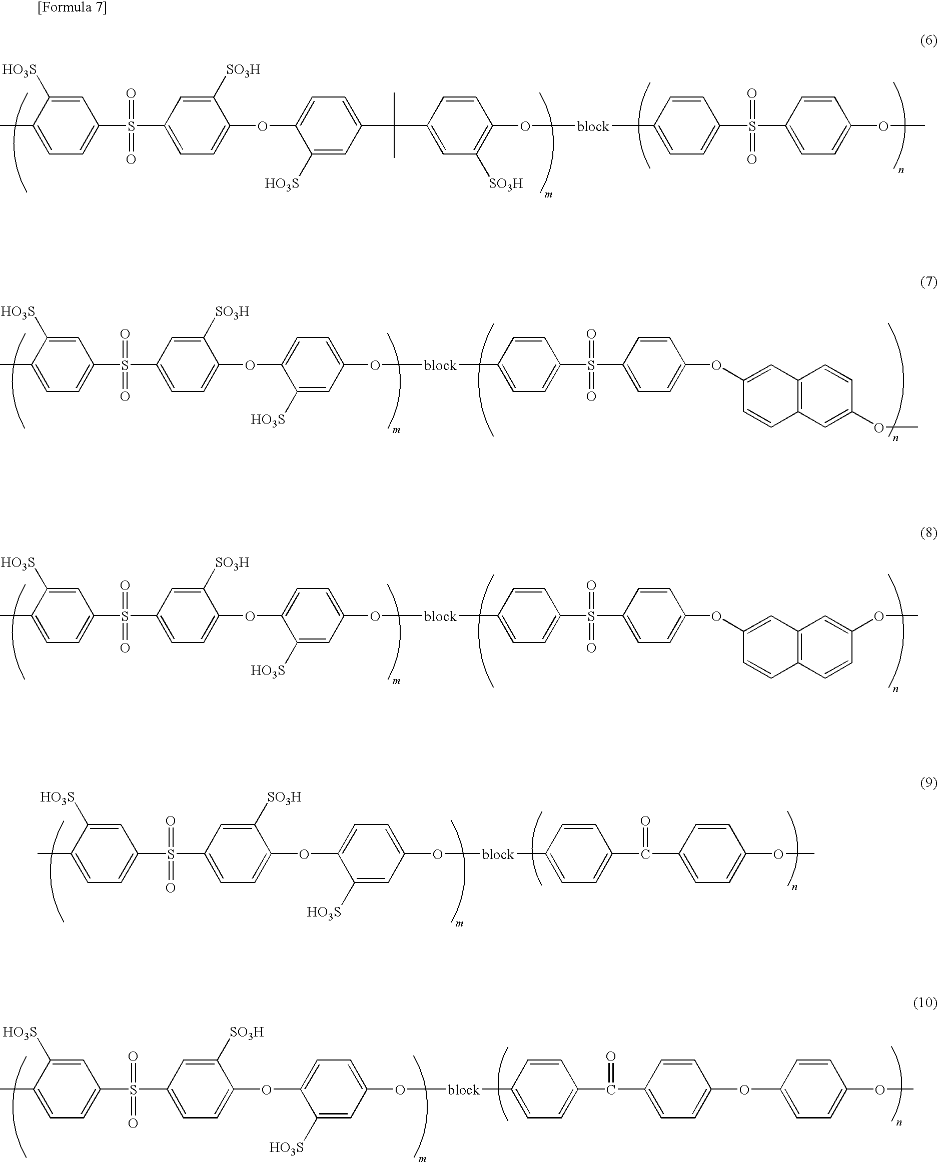

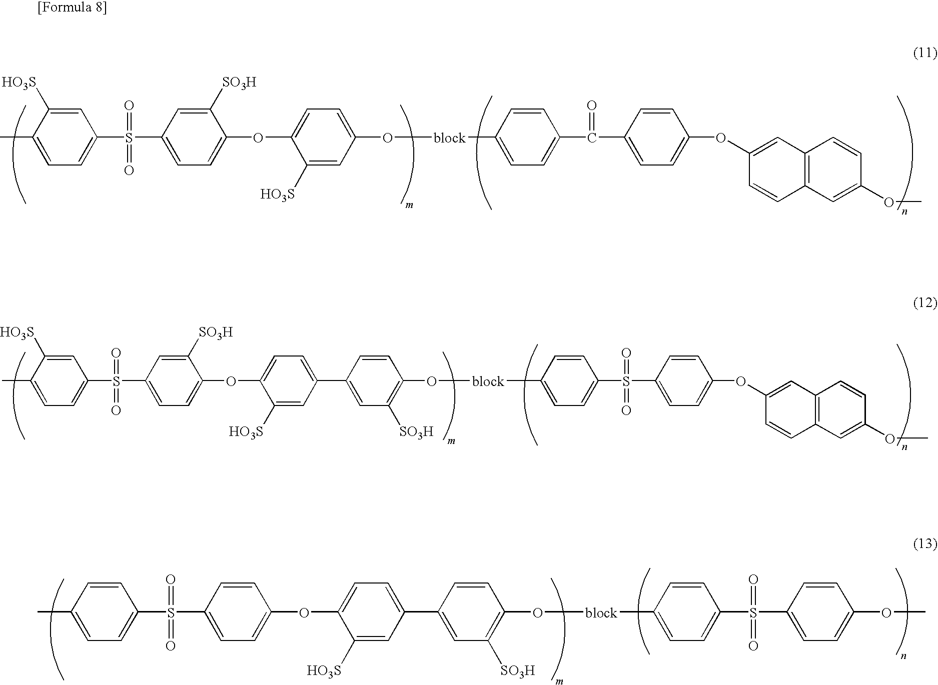

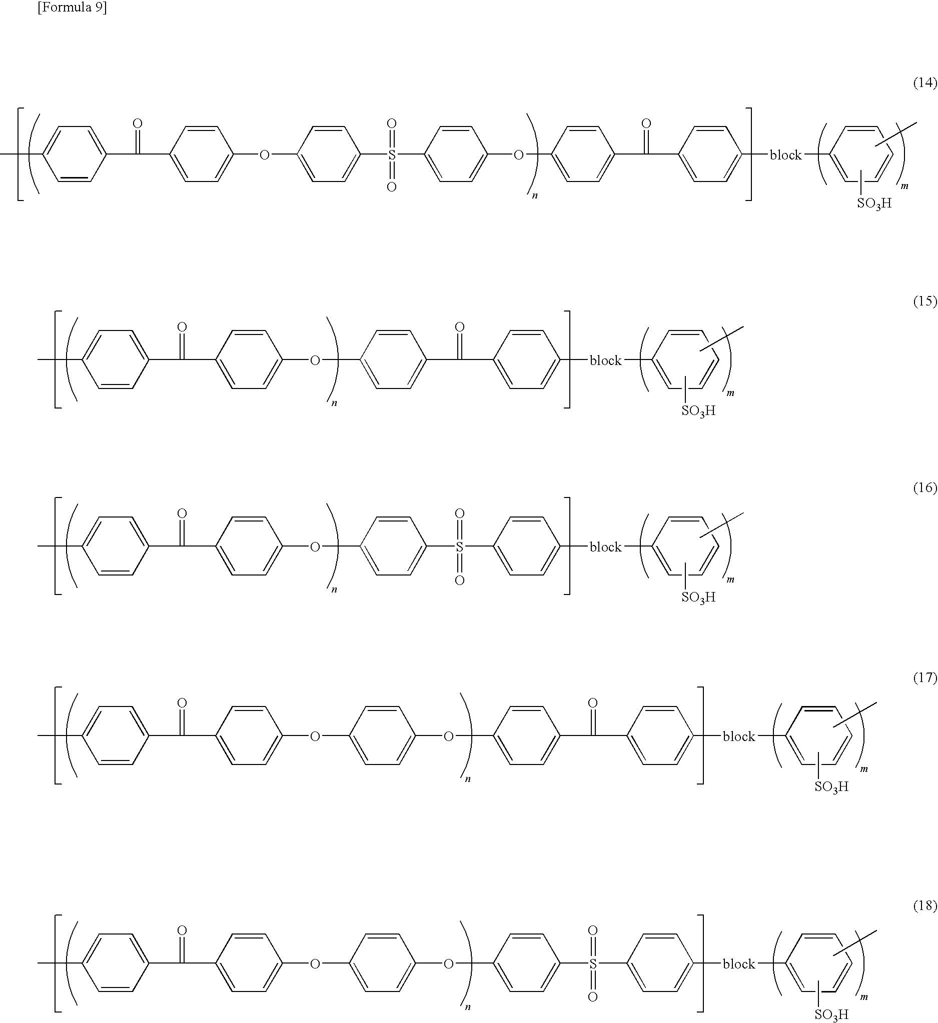

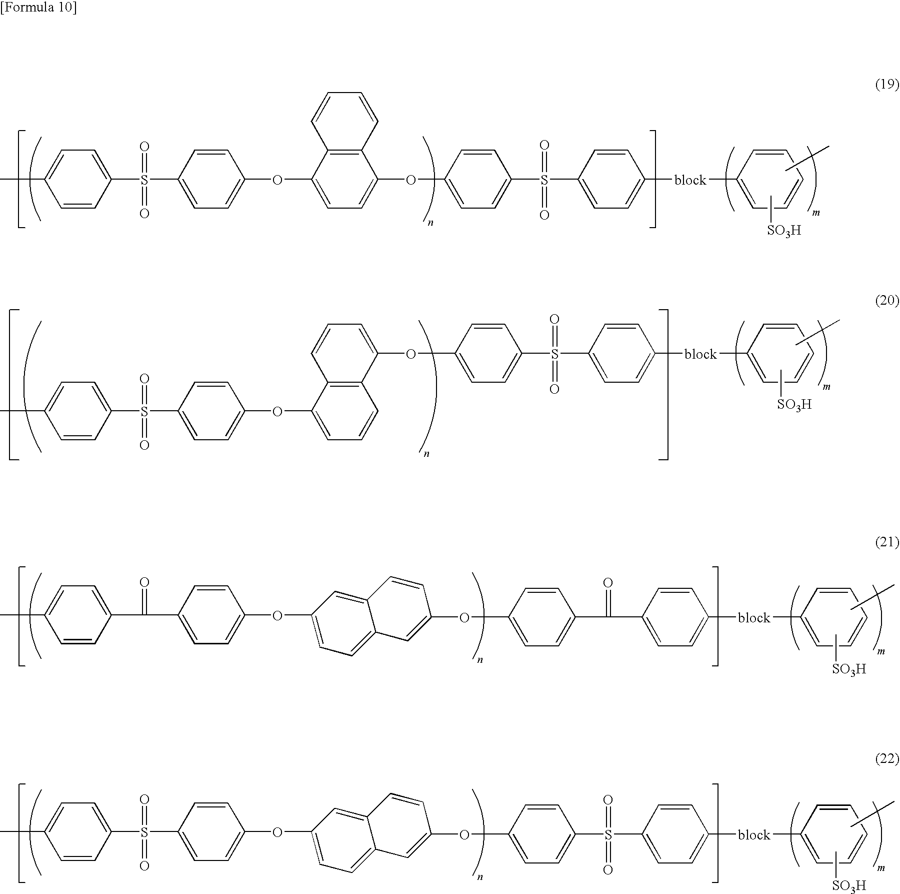

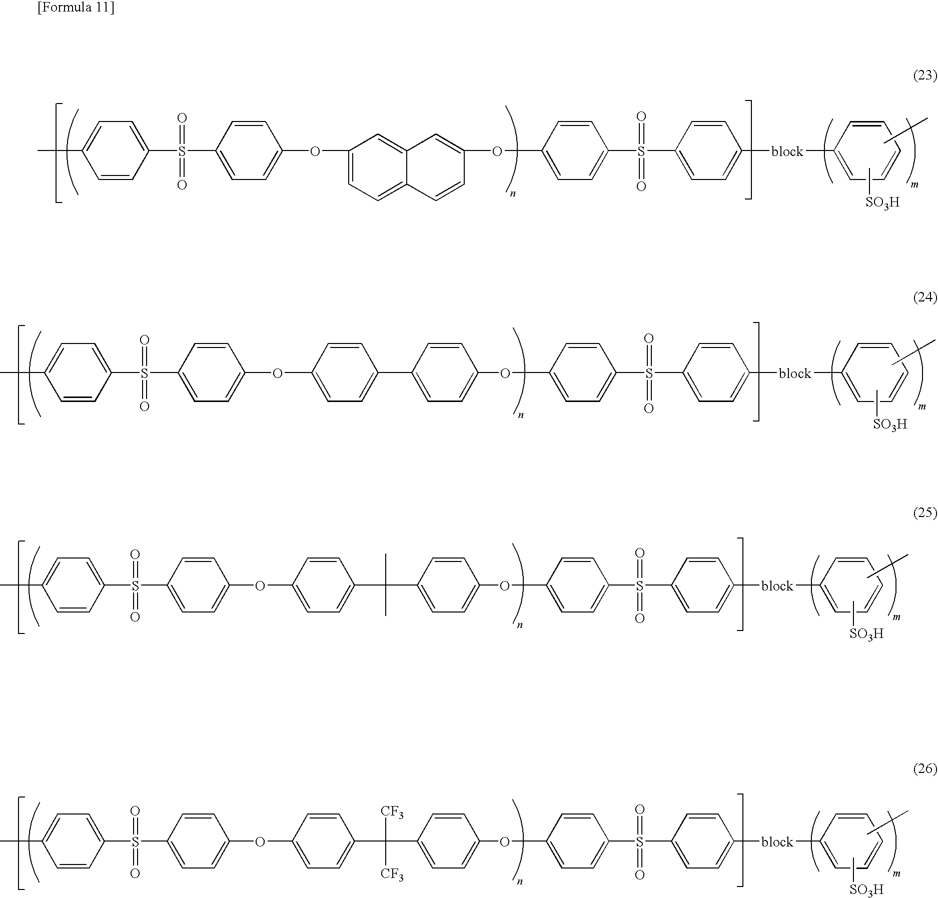

Examples of the more preferred proton conductive polymers are those of the above (2), (7), (8), (16), (18), (22)-(25), etc., and especially preferred are those of (16), (18), (22), (23), (25), etc.

When the proton conductive polymers are the above block copolymers, it is especially preferred that both of the bock (A) having proton exchange group and the block (B) having substantially no proton exchange group do not substantially have substituent comprising a halogen atom. The halogen atoms are fluorine, chlorine, bromine and iodine.

Here, “do not substantially have” means “may have the substituent in such a number as not affecting the effect of the present invention”. Specifically, it means that the blocks do not have the substituent group comprising a halogen atom in the number of 0.05 or more per repeat unit.

On the other hand, examples of the substituents which may be contained in the blocks are alkyl group, alkoxy group, aryl group, aryloxy group, and acyl group, and alkyl group is preferred. These substituents are preferably those of 1-20 carbon atoms, and examples thereof are substituents of less carbon atoms, such as methyl group, ethyl group, methoxy group, ethoxy group, phenyl group, naphthyl group, phenoxy group, naphthyloxy group, acetyl group and propionyl group.

In case the block copolymers contain halogen atom, for example, hydrogen fluoride, hydrogen chloride, hydrogen bromide, hydrogen iodide, or the like is generated during operation of fuel cell, and may corrode the members of fuel cell, which is not preferred.

The number-average molecular weight of the proton conductive polymer is preferably 5000-1000000, especially preferably 15000-400000 in terms of polystyrene.

The solution casting method for forming membrane using a solution is specifically a method which comprises dissolving at least one proton conductive polymer, if necessary, together with other components such as other polymers and additives in a suitable solvent, cast coating the resulting solution (polymer electrolyte solution) on a specific base, and removing the solvent to form a polymer electrolyte membrane.

The method for preparation of the polymer electrolyte solution is not particularly limited, and it can be prepared by adding separately two or more components constituting the polymer electrolyte membrane to a solvent and dissolving them, for example, by adding separately two or more proton conductive polymers to a solvent or adding separately the proton conductive polymer and other components to a solvent.

The solvents used for formation of membrane are not particularly limited as long as they can dissolve polyarylene polymers and can be removed later. There can be suitably used non-protonic polar solvents such as dimethylformamide (DMF), dimethylacetamide (DMAc), N-methyl-2-pyrrolidone (NMP) and dimethylsulfoxide (DMSO), chlorine-containing solvents such as dichloromethane, chloroform, 1,2-dichloroethane, chlorobenzene and dichlorobenzene, alcohols such as methanol, ethanol and propanol, alkylene glycol monoalkyl ethers such as ethylene glycol monomethyl ether, ethylene glycol monoethyl ether, propylene glycol monomethyl ether and propylene glycol monoethyl ether, and the like. These may be used each alone, but, if necessary, two or more solvents may be used in admixture. Among them, DMSO, DMF, DMAc and NMP are preferred because they have high dissolving power for the polymers.

For improving chemical stability of the polymer electrolyte membrane such as oxidation resistance or radical resistance, a chemical stabilizer may be added to the proton conductive polymer as long as the effect of the present invention is not damaged. Examples of the stabilizers added are antioxidants and the like, and mention may be made of additives as disclosed in JP-A-2003-201403, JP-A-2003-238678 (US2004/210007A), and JP-A-2003-282096 (US2003/16684A). Alternatively, as chemical stabilizers, there may be used phosphonic acid group-containing polymers disclosed in JP-A-2005-38834 (US2006/159972A) and JP-A-2006-66391 (US2006/280999A) and represented by the following formulas:

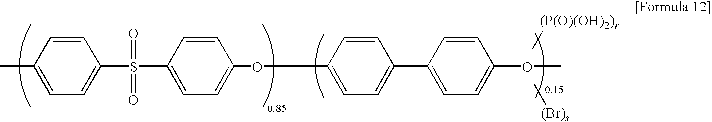

(r=1-2.5, s=0-0.5, and the suffix of repeat units shows a mol fraction of repeat unit),

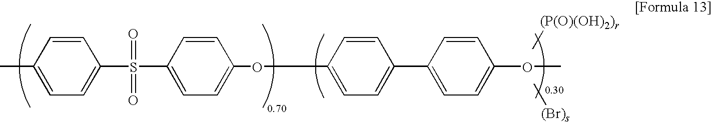

(r=1-2.5, s=0-0.5, and the suffix of repeat units shows a mol fraction of repeat unit).

The content of the chemical stabilizer is preferably 20 wt % or less for the whole solution, and if the content is more than the above range, the performance of the polymer electrolyte membrane may deteriorate.

The supporting base used for cast coating in solution casting method is preferably a base on which the membrane can be continuously formed. A base on which the membrane can be continuously formed is a base which can be wound round a paper tube or a plastic tube in the form of a roll and can be held as a roll and bears an external force such as bending to some extent without breaking, and which can be continuously wound off or up after being fixed in the form of a roll. In general, those bases which are inferior in flexibility or broken by flexing, such as glass sheets and metal sheets, are not preferred.

Use of a base capable of continuous forming of membranes is industrially advantageous because productivity is improved. Preferably, the base has a width of 100 mm or more and a length of 10 m or more. More preferably, the base has a width of 150 mm or more and a length of 50 m or more, and further preferably, the base has a width of 200 mm or more and a length of 100 m or more.

Furthermore, the supporting base preferably has such heat resistance and dimensional stability that it can stand drying conditions during formation of membrane by casting, and moreover preferably has solvent resistance to the above solvents or water resistance. Furthermore, the base preferably does not strongly adhere to the polymer electrolyte membrane after coating and drying, and can be peeled off. Here, “having heat resistance or dimensional stability” means that the base does not show heat deformation when it is dried using a drying oven for removal of solvent after cast coating the polymer electrolyte solution. Moreover, “having solvent resistance” means that the base per se does not substantially dissolve out with solvent in the polymer electrolyte solution. Further, “having water resistance” means that the base per se does not substantially dissolve out in an aqueous solution having a pH of 4.0-7.0. Besides, “having solvent resistance” and “having water resistance” are concepts comprising that the base does not suffer from chemical deterioration with solvent or water and is high in dimensional stability and does not swell or shrink.

As a supporting base on which the difference in water contact angle on both surfaces of the polymer electrolyte membrane can be reduced by cast coating, suitable is a supporting base in which the surface to be cast coated is made of metal or metal oxide.

The material of the surface of base to be cast coated includes metal layer or metal oxide layer. Specifically, the metal layer includes, for example, aluminum, copper, iron, stainless steel (SUS), gold, silver, platinum or alloys thereof. The metal oxide layer includes, for example, oxides and silicone oxides of the above metals, etc.

These metals and metal oxides may constitute alone the supporting base or may be formed on a resin film by lamination, vapor deposition or sputtering to constitute the supporting base. The resin films include, for example, polyolefin films, polyester films, polyamide films, polyimide films, and fluorine-containing resin films. Of these films, polyester films and polyimide films are preferred because they are excellent in heat resistance, dimensional stability and solvent resistance. As the polyester films, mention may be made of polyethylene terephthalate, polyethylene naphthalate, polybutylene terephthalate, aromatic polyesters, etc., and polyethylene terephthalate is industrially preferred not only from the point of characteristics, but also from the points of general-purpose properties and cost.

Among the combinations of resin film layer with metal thin film layer or metal oxide thin film layer, preferred are such combinations that the rein film layer comprises polyethylene terephthalate and the metal thin film layer or metal oxide thin film layer comprises aluminum-laminated layer, aluminum-vapor deposited layer, alumina-vapor deposited layer, silica-vapor deposited layer, alumina-silica binary vapor deposited layer or the like. As these laminate films, there are films used as packaging materials.

Alumina-vapor deposited polyethylene terephthalate films include, for example, BARRIALOX (trade name) manufactured by Toray Advanced Film Co., Ltd., silica-vapor deposited polyethylene terephthalate films include, for example, MOS (trade name) manufactured by Oike & Co., Ltd., alumina-silica binary vapor deposited films include, for example, ECOSYAR (trade name) manufactured by Toyobo Co., Ltd.

Depending on uses, surface treatments which can change wettability of the surface of the supporting base may be carried out. The treatments which can change wettability of the surface of the supporting base include general processes, e.g., hydrophilic treatments such as corona treatment and plasma treatment, water-repellent treatments such as fluorine treatment, etc.

One embodiment of the above-mentioned membrane electrode assembly comprising a pair of electrodes and a polymer electrolyte membrane interposed between the electrodes, and one embodiment of a fuel cell comprising the membrane electrode assembly will be explained below.

The gas diffusion layer constituting the electrode can be formed using a gas diffusion layer sheet comprising electrically conductive porous body such as carbon porous body, e.g., carbon paper, carbon cloth and carbon felt, and metal mesh or metal porous body made of metals such as titanium, aluminum, copper, nickel, nickel-chromium alloy, copper and alloy thereof, silver, aluminum alloy, zinc alloy, lead alloy, titanium, niobium, tantalum, iron, stainless steel, gold and platinum which have gas diffusibility for efficient feeding of gas to the catalyst layer, electrical conductivity and strength required for material constituting the gas diffusion layer. The electrically conductive porous body preferably has a thickness of about 50-500 μm.

The gas diffusion layer sheet may be a single layer of the electrically conductive porous body as mentioned above, but a water-repellent may be provided on the side facing the catalyst layer for efficient discharge of water in the catalyst layer out of the gas diffusion layer. The water-repellent layer usually has a porous structure comprising electrically conductive particles such as carbon particles and carbon fibers, water-repellent resins such as polytetrafluoroethylene (PTFE).

The method for forming the water-repellent layer on the electrically conductive porous body is not particularly limited, and a water-repellent layer ink prepared by mixing, for example, electrically conductive particles such as carbon particles and a water-repellent resin, and, if necessary, other components with a solvent, e.g., an organic solvent such as ethanol, propanol or propylene glycol, water or a mixture thereof is coated on at least the surface of the electrically conductive porous body which faces the catalyst layer, and then the coat is dried and/or fired to form the water-repellent layer.

The water-repellent layer may also be formed by impregnation coating the water-repellent resin such as polytetrafluoroethylene by a bar coater or the like.

The catalyst layer usually contains an electrode catalyst having catalytic activity for electrode reaction and besides a proton conductive polymer. The electrode catalyst is not particularly limited as long as it has catalytic activity for electrode reaction, and there may be used those which are generally used as electrode catalyst. Examples are metals such as platinum, ruthenium, iridium, rhodium, palladium, lead, iron, chromium, cobalt, nickel, manganese, vanadium, molybdenum, gallium and aluminum, and alloys thereof. Preferred are platinum and platinum alloys such as platinum-ruthenium alloy.

The electrode catalyst is usually supported on electrically conductive particles so that transfer of electrons in electrode reaction at the electrode catalyst can be smoothly performed and dispersibility of the electrode catalyst in the electrode can be ensured. As the electrically conductive particles, metal particles can also be used in addition to carbon particles such as carbon black. The shape of electrically conductive particles are not limited to spherical shape, and include those of relatively large aspect ratio, such as fibrous shape.

The proton conductive polymer contained in the catalyst layer is not particularly limited, and there may be used those which are generally used in solid polymer type fuel cells. For example, there may be used fluorine-containing electrolyte resins, e.g., perfluorocarbonsulfonic acid resins represented by NAFION (trade name; manufactured by Du Pont de Nemours, E.I. & Co.), and besides hydrocarbon electrolyte resins obtained by introducing proton exchange groups such as sulfonic acid group, boronic acid group, phosphonic acid group and hydroxyl group into hydrocarbon resins such as polyether sulfone, polyimide, polyether ketone, polyether ether ketone and polyphenylene. Specific examples are those exemplified above as proton conductive polymers constituting the polymer electrolyte membranes.

The catalyst layer may contain, if necessary, other components such as water-repellent polymers (e.g., polytetrafluoroethylene) and binders in addition to the electrically conductive particles supporting the electrode catalyst and the proton conductive polymer.

The method for producing the membrane electrode assembly is not particularly limited.

For example, the catalyst layer can be formed using a catalyst ink prepared by dissolving or dispersing in a solvent the components forming the catalyst layer. Specifically, the catalyst layer can be formed on the surface of electrolyte membrane or on the surface of gas diffusion layer by directly coating the catalyst ink on the surface of electrolyte membrane, directly coating the catalyst ink on a gas diffusion layer sheet which is a gas diffusion layer, or coating and drying the catalyst ink on a transfer base to prepare a catalyst layer transfer sheet, and heat transferring the catalyst layer of the transfer sheet to the electrolyte membrane or gas diffusion layer sheet.

The method for coating of the catalyst ink is not particularly limited, and there may be employed, for example, spraying method, screen printing method, doctor blade method, gravure printing method, die coating method, etc.

The electrolyte membrane-catalyst layer assembly made by providing the catalyst layer on the surface of the electrolyte membrane by direct coating or transfer of catalyst ink is bonded to the gas diffusion layer sheets usually by subjecting to heat pressure bonding in the state of being interposed between the gas diffusion layer sheets, thereby obtaining a membrane electrode assembly having electrodes comprising catalyst layer and gas diffusion layer and disposed on both surfaces of the electrolyte membrane.

The gas diffusion layer-catalyst layer assemblies made by providing the catalyst layer on the surface of the gas diffusion layer sheet by direct coating or transfer of catalyst ink are bonded to the electrolyte membrane by subjecting to heat pressure bonding in the state of interposing the electrolyte membrane, thereby obtaining a membrane electrode assembly having electrodes comprising catalyst layer and gas diffusion layer on both surfaces of the electrolyte membrane.

The membrane electrode assembly produced as mentioned above is interposed between separators comprising carbonaceous material, metallic material, or the like to form a cell, which is incorporated in a fuel cell.

### Examples

### [Production of Electrolyte Membrane]

A proton conductive polymer was dissolved in dimethyl sulfoxide to prepare a solution of 10 wt % in concentration. The solution was cast coated on a supporting base and dried (drying conditions: temperature 80° C., 60 minutes) to produce a hydrocarbon polymer electrolyte membrane. The polymer electrolyte membrane after dried was washed with ion exchanged water to remove completely the solvent. This membrane was immersed in 2N hydrochloric acid for 2 hours, then washed again with ion exchanged water, and further air-dried to produce a polymer electrolyte membrane. Water contact angle was measured on the supporting base side and the air-interface side of the resulting hydrocarbon polymer electrolyte membrane.

### (Measurement of Water Contact Angle)

The polymer electrolyte membrane was left to stand in an atmosphere of 23° C. 50RH % for 24 hours, and thereafter measurement of water contact angle was conducted using a contact angle meter (model CA-A manufactured by Kyowa Interface Science Co., Ltd.) by dropping a water drop of 2.0 mm in diameter on the surface of the polymer electrolyte membrane and, after 5 seconds, measuring a contact angle between the surface of the membrane and the water drop by droplet method.

### Synthesis Example 1

In argon atmosphere, in a flask equipped with an azeotropic distillation device were charged 142.2 parts by weight of DMSO, 55.6 parts by weight of toluene, 5.7 parts by weight of sodium 2,5-dichlorobenzenesulfonate, 2.1 parts by weight of the following polyether sulfone of terminal chloro type

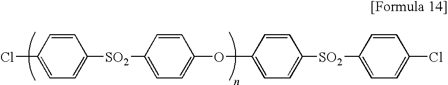

(SUMIKAEXCEL PES5200P manufactured by Sumitomo Chemical Co., Ltd.) and 9.3 parts by weight of 2,2′-bipyridyl, followed by stirring. Then, bath temperature was raised to 100° C., and toluene was distilled off with heating under reduced pressure to remove water in the system by azeotropic dehydration, followed by cooling to 65° C. and then returning to normal pressure. Then, 15.4 parts by weight of bis(1,5-cyclooctadiene)nickel(0) was added, then the temperature was raised to 70° C., and stirring was carried out at the same temperature for 5 hours. After leaving the reaction mixture for cooling, it was poured into a large amount of methanol to precipitate a polymer, which was filtered off. Thereafter, the polymer was washed and filtered repeatedly several times with 6 mol/L hydrochloric acid, then washed with water until the filtrate reached neutral, and dried under reduced pressure to obtain 3.0 parts by weight of the following desired polyarylene block copolymer (IEC=2.2 meq/g, Mn=103000, Mw=257000).

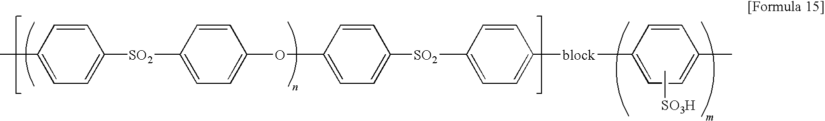

TABLE 1

Water contact angle (°)

| | Example | Comparative Example |
|---|---|---|
| Surface on air- | 44 | 31 |
| interface side | | |
| Surface on | 47 | 90 |
| base side | | |

As shown in Table 1, the hydrocarbon polymer electrolyte membrane produced by solution casting of a mixture of the proton conductive polymer of Synthesis Example 1 and the phosphonic acid group-containing polymer disclosed in JP-A-2006-66391 (US2006/280999A)([0058], see the following formula) (90:10 in weight ratio) differed in difference in water contact angle in the case of Example using aluminum sheet base and in the case of Comparative Example using PET (polyethylene terephthalate) base. In the case of using aluminum sheet base of Example, the difference between the water contact angles on the surface of the aluminum sheet base side and on the surface of the air-interface side was 3°, and thus the difference in water contact angle was smaller as compared with the case of using PET base of Comparative Example (difference in water contact angle: 59°), and besides the hydrophilicity was higher on both the aluminum sheet base side surface and the air-interface side.

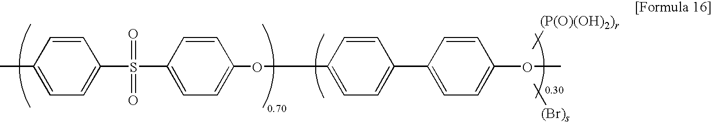

(r=1.6, s=0.0, and the suffix of repeat units shows a mol fraction of repeat unit).

### [Evaluation of Electricity Generation Performance]

(Production of Membrane Electrode Assembly)

1 g of Pt/C catalyst (Pt supporting rate: 50 wt %), 4 ml of 10 wt % solution of perfluorocarbonsulfonic acid (trade name: Nafion), 5 ml of ethanol and 5 ml of water were mixed by an ultrasonic washing machine and a centrifugal stirrer to prepare a slurry of catalyst ink.

The resulting catalyst ink was spray coated on both surfaces of the above hydrocarbon polymer electrolyte membrane to form a catalyst layer (13 cm²). In this case, the catalyst ink was coated so that the amount of Pt per unit area of the catalyst layer was 0.5 mg/cm².

The resulting electrolyte membrane with catalyst layer was put between carbon cloths for gas diffusion layer to obtain a membrane electrode assembly.

The resulting membrane electrode assembly was interposed between two carbon separators to make a single cell.

(Electricity Generation Test)

### Example 1

Hydrogen gas and air were fed to the single cell so that the surface on the aluminum base side of the hydrocarbon polymer electrolyte membrane was on the oxidant electrode side, and the surface on the air-interface side of the hydrocarbon polymer electrolyte membrane was on the fuel electrode side, and electricity generation test was conducted under the following low humidification conditions. The results are shown in FIG. 2 (low humidification conditions).

### Conditions for Evaluation of Electricity Generation

Low humidification conditions

Hydrogen gas: 270 ml/min

Air: 860 ml/min

Cell temperature: 80° C.

Bubbler temperature on anode side: 45° C.

Bubbler temperature on cathode side: 55° C.

Back pressure on anode side: 0.1 MPa (gauge pressure)

Back pressure on cathode side: 0.1 MPa (gauge pressure)

### Comparative Example 1

Hydrogen gas and air were fed to the single cell so that the surface of PET base side of the hydrocarbon polymer electrolyte membrane was on the oxidant electrode side, and the surface on the air-interface side of the hydrocarbon polymer electrolyte membrane was on the fuel electrode side, and electricity generation test was conducted under the low humidification conditions in the same manner as in Example 1. The results are shown in FIG. 2 (low humidification conditions).

As can be seen from FIG. 2, the single cell comprising the membrane electrode assembly of Example 1 which used a membrane small in difference in contact angle of the polymer electrolyte membrane showed excellent electricity generation performance in the state of low humidification.

On the other hand, in the single cell comprising the membrane electrode assembly of Comparative Example 1 which used a membrane large in difference in contact angle of the polymer electrolyte membrane, an abrupt decrease of voltage began to occur at a current density of about 1.0 A/cm², and the cell was inferior to the cell of Example 1 in electricity generation performance in the high current density region. Furthermore, as shown in Table 2, when cell resistance at 1.0 A/cm² was compared, the cell resistance of Example was lower than that of Comparative Example.

TABLE 2

| | | Cell resistance |
|---|---|---|
| | Voltage (V)¹⁾ | (mΩ)²⁾ |
| Example | 0.60 | 11 |
| Comparative | 0.55 | 13 |
| Example | | |

¹⁾Value when current density was 1.0 A/cm²
²⁾Value when current density was 1.0 A/cm²

That is, in the single cell of Example using a polymer electrolyte membrane having no difference in hydrophilicity between both surfaces, bonding at membrane-electrode interface between polymer electrolyte membrane and electrode was improved, and migration of water occurred readily. As a result, operation performance in high current density region under low humidification conditions was improved. Even under the conditions where drying of polymer electrolyte membrane readily occurs, such as high current density region under low humidification conditions, excellent electricity generation performance was exhibited, and thus it can be expected that excellent electricity generation performance is developed even under high temperature conditions.

### INDUSTRIAL APPLICABILITY

According to the present invention, there is provided a membrane electrode assembly for fuel cell that irrespectively of the front or backside of polymer electrolyte membrane, exhibits high output performance, and that exhibits strong bonding at an interface between polymer electrolyte membrane-electrode even under low humidification condition or high temperature condition, or in high current density region, realizing appropriate water management and excellent output performance, and further a fuel cell having the assembly is provided.

### BRIEF DESCRIPTION OF DRAWING

[FIG. 1] A schematic view showing one embodiment of single cell having the membrane electrode assembly of the present invention.

[FIG. 2] A graph showing the results of electricity generation tests under low humidification conditions in Example 1 and Comparative Example 1.

### DESCRIPTION OF REFERENCE NUMERALS

1: Polymer electrolyte membrane

2: Fuel electrode

3: Oxidant electrode

4a: Catalyst layer on fuel electrode side

4b: Catalyst layer on oxidant electrode side

5a: Gas diffusion layer on fuel electrode side

5b: Gas diffusion layer on oxidant electrode side

6: Membrane electrode assembly

7a: Separator on fuel electrode side

7b: Separator on oxidant electrode side

8a, 8b: Flowing channels

100: Single cell

1. A membrane electrode assembly for fuel cell which comprises a polymer electrolyte membrane comprising at least one proton conductive polymer, a fuel electrode disposed on one surface of the polymer electrolyte membrane, and an oxidant electrode disposed on another surface of the polymer electrolyte membrane, wherein when hydrophilicity of the surface of the polymer electrolyte membrane is specified in terms of water contact angle, the difference between water contact angle on one surface of the polymer electrolyte membrane and that on another surface thereof is 30° or less.

2. A membrane electrode assembly for fuel cell according to claim 1, wherein when hydrophilicity of the surface of the polymer electrolyte membrane is specified in terms of water contact angle and when the surface having a relatively high hydrophilicity is referred to as the first surface and the surface having a relatively low hydrophilicity is referred to as the second surface, the difference between water contact angles on the first surface and the second surface is 30° or less.

3. A membrane electrode assembly for fuel cell according to claim 1, wherein the water contact angles on one surface and another surface of the polymer electrolyte membrane are both 10° or more and 60° or less.

4. A membrane electrode assembly for fuel cell according to claim 1, wherein the polymer electrolyte membrane is obtained by solution casting a polymer electrolyte solution prepared by dissolving a polymer electrolyte in a solvent on a continuous supporting base.

5. A membrane electrode assembly for fuel cell according to claim 1, wherein the polymer electrolyte membrane is a hydrocarbon polymer electrolyte membrane.

6. A membrane electrode assembly for fuel cell according to claim 1, wherein the proton conductive polymer comprises an aromatic ring in main chain and a proton exchange group directly bonded to the aromatic ring or indirectly bonded to the aromatic ring through other atom or atomic group.

7. A membrane electrode assembly for fuel cell according to claim 6, wherein the proton conductive polymer comprises a side chain.

8. A membrane electrode assembly for fuel cell according to claim 1, wherein the proton conductive polymer comprises an aromatic ring in main chain and may further comprise a side chain comprising an aromatic ring, and at least one of the aromatic ring of the main chain and the aromatic ring of the side chain comprises a proton exchange group directly bonded to the aromatic ring.

9. A membrane electrode assembly for fuel cell according to claim 6, wherein the proton exchange group is a sulfonic acid group.

10. A membrane electrode assembly for fuel cell according to claim 6, wherein the proton conductive polymer comprises at least one repeat unit having a proton exchange group and selected from those of the following formulas (1a)-(4a): 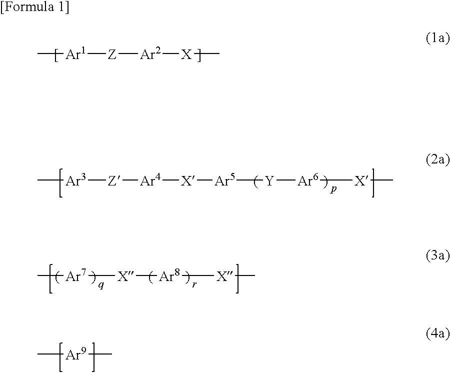
(in the above formula, Ar¹-Ar⁹ independently of one another represent a divalent aromatic group which comprises an aromatic ring in main chain and may further comprise a side chain comprising an aromatic ring, with the proviso that at least one of the aromatic ring of the main chain and the aromatic ring of the side chain comprises a proton exchange group directly bonded to the aromatic ring, Z and Z′ independently of one another represent CO or SO₂, X, X′ and X″ independently of one another represent O or S, Y represents a direct bonding or a methylene group which may have a substituent, p represents 0, 1 or 2, and q and r independently of one another represent 1, 2 or 3) and at least one repeat unit selected from those of the following formulas (1b)-(4b) and having substantially no proton exchange group: 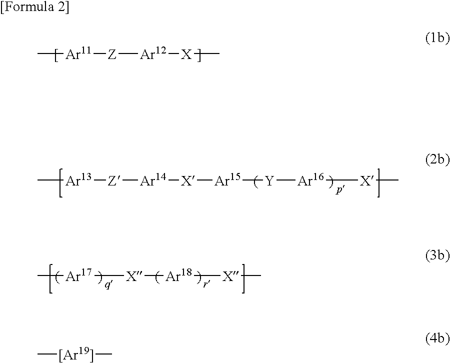
(in the above formula, Ar¹¹-Ar¹⁹ independently of one another represent a divalent aromatic group which may have a substituent as a side chain, Z and Z′ independently of one another represent CO or SO₂, X, X′ and X″ independently of one another represent O or S, Y represents a direct bonding or a methylene group which may have a substituent, p′ represents 0, 1 or 2, and q′ and r′ independently of one another represent 1, 2 or 3).

11. A membrane electrode assembly for fuel cell according to claim 6, wherein the proton conductive polymer is a block copolymer comprising a block (A) having proton exchange group and a block (B) having substantially no proton exchange group.

12. A membrane electrode assembly for fuel cell according to claim 6, wherein the polymer electrolyte membrane comprises a structure of micro phase being separated into two or more phases.

13. A membrane electrode assembly for fuel cell according to claim 12, wherein the polymer electrolyte membrane comprises as the proton conductive polymer a block copolymer comprising a block (A) having proton exchange group and a block (B) having substantially no proton exchange group and comprises a micro phase separation structure comprising a phase where density of the block (A) having proton exchange group is high and a phase where density of the block (B) having substantially no proton exchange group is high.

14. A membrane electrode assembly for fuel cell according to claim 6, wherein the proton conductive polymer comprises one or more blocks (A) having proton exchange group and one or more blocks (B) having substantially no proton exchange group, and the block (A) having proton exchange group comprises the repeat structure represented by the following formula (4a′) and the block (B) having substantially no proton exchange group has at least one repeat structure selected from those represented by the following formulas (1b′), (2b′) and (3b′): 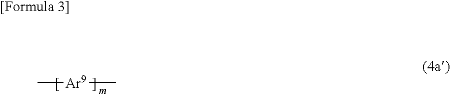
(in the above formula, m represents an integer of 5 or more, and Ar⁹ represents a divalent aromatic group which may be substituted with a fluorine atom, a substituted or unsubstituted alkyl group of 1-10 carbon atoms, an alkoxy group of 1-10 carbon atoms, an aryl group of 6-18 carbon atoms, an aryloxy group of 6-18 carbon atoms or an acyl group of 2-20 carbon atoms, and Ar⁹ comprises a proton exchange group bonded directly or through a side chain to an aromatic ring constituting the main chain), 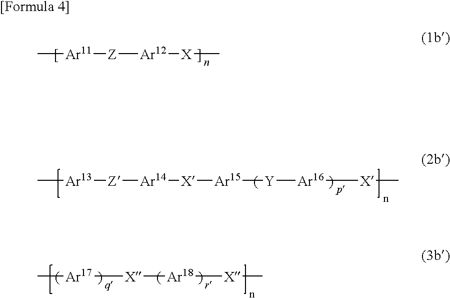
(in the above formula, n represents an integer of 5 or more, and Ar¹¹-Ar¹⁸ independently of one another represent a divalent aromatic group which may be substituted with an alkyl group of 1-18 carbon atoms, an alkoxy group of 1-10 carbon atoms, an aryl group of 6-10 carbon atoms, an aryloxy group of 6-18 carbon atoms or an acyl group of 2-20 carbon atoms, and other signs are the same as defined in the formulas (1b)-(3b).

15. A membrane electrode assembly for fuel cell according to claim 6, wherein the proton conductive polymer comprises one or more blocks (A) having proton exchange group and one or more blocks (B) having substantially no proton exchange group, and the proton exchange group is directly bonded to the aromatic ring of main chain in the block having proton exchange group.

16. A membrane electrode assembly for fuel cell according to claim 6, wherein the proton conductive polymer comprises one or more blocks (A) having proton exchange group and one or more blocks (B) having substantially no proton exchange group, and the block (A) having proton exchange group and the block (B) having substantially no proton exchange group both do not have a substituent comprising a halogen atom.

17. A membrane electrode assembly for fuel cell according to claim 1, wherein both surfaces of the membrane are not subjected to surface treatment.

18. A membrane electrode assembly for fuel cell according to claim 1, wherein the polymer electrolyte membrane is produced by cast coating a solution comprising the proton conductive polymer constituting the polymer electrolyte membrane on a supporting base and drying the coat.

19. A membrane electrode assembly for fuel cell according to claim 18, wherein the surface of the supporting base to be subjected to cast coating has a metal layer or a metal oxide layer.

20. A membrane electrode assembly for fuel cell according to claim 19, wherein the supporting base is in the form of a roll for being able to continuously form the membrane.

21. A fuel cell having the membrane electrode assembly according to claim 1.
